(19) United States
(12) Patent Application Publication
(10) Pub. No.: US 2014/0117928 A1
(43) Pub. Date: May 1, 2014

(54) WIRELESS CHARGING THIN-FILM BATTERY

(71) Applicant: HON HAI PRECISION INDUSTRY CO., LTD., NEW TAIPEI (TW)

(72) Inventor: KUANG-YAO LIAO, New Taipei (TW)

(73) Assignee: HON HAI PRECISION INDUSTRY CO., LTD., New Taipei (TW)

(21) Appl. No.: 14/059,467

(22) Filed: Oct. 22, 2013

(30) Foreign Application Priority Data
Oct. 31, 2012 (TW) 101221107

(51) Int. Cl. H02J 7/02

(52) U.S. Cl. CPC H02J 7/025
USPC 320/108

(57) ABSTRACT

A wireless charging film-battery includes a flexible printed circuit board which includes a first surface, a film-battery module which is arranged on the first surface of the flexible printed circuit board; a wireless charging module and an antenna which are printed on the first surface of the flexible printed circuit board and the wireless charging module is electrically connected to the film-battery module.

### BACKGROUND

1. Technical Field

The present disclosure relates to a thin-film battery, especially to a wireless charging thin-film battery.

2. Description of Related Art

With recent innovations in 3C products, the pursuit for ultimate light weight and shot depth is experiencing a dramatic surge in popularity. But, now days, wireless charging antenna, RF antenna which are discrete products premade or purchased from other factories and are assembled together with the film battery on a flexible printed circuit board individually, and the discrete wireless charging antenna and RF antenna takes up a lot of space, so the pursuit for ultimate light weight and shot depth is severely limited.

Therefore, what is needed is a wireless charging film-battery which saves a lot of space.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a block program of a wireless charging film-battery in one embodiment.

FIG. 2 is a schematic view of a wireless charging film-battery of FIG. 1.

FIG. 3 is a schematic view of a wireless charging film-battery in another embodiment.

### DETAILED DESCRIPTION

The disclosure including the accompanying drawings, is illustrated by way of example and not by way of limitation. It should be noted that references to “an” or “one” embodiment in this disclosure are not necessarily to the same embodiment, and such references mean at least one.

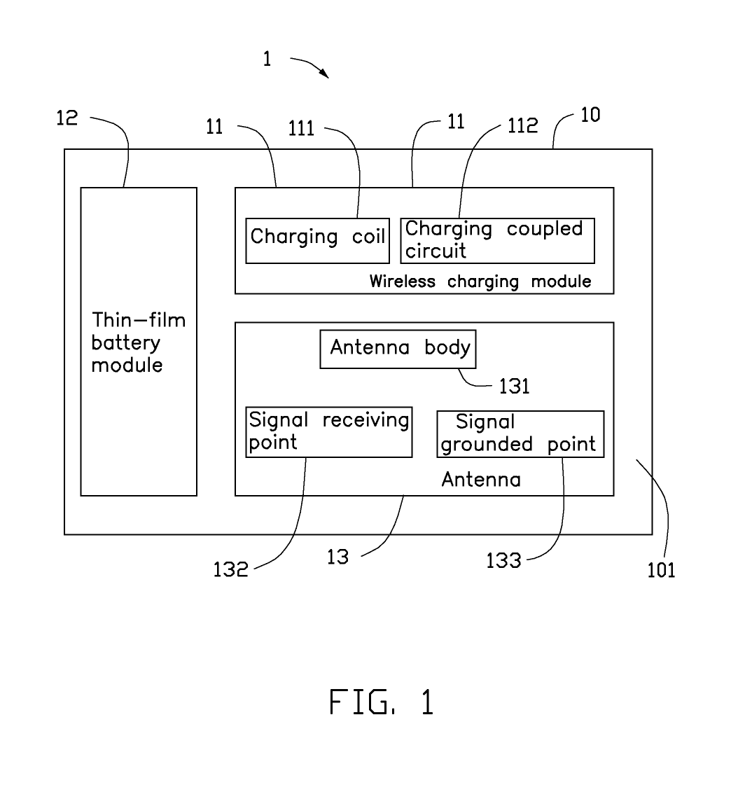

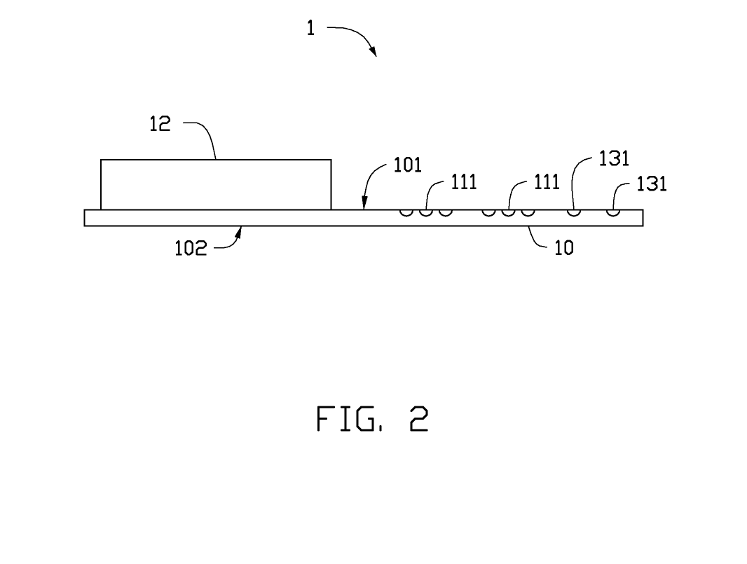

FIGS. 1 and 2 show a wireless charging film-battery 1 of the disclosure. The wireless charging film-battery 1 includes a flexible printed circuit board 10. The flexible printed circuit board 10 includes a first surface 101 and a second surface 102 opposite to the first surface 101. The wireless charging film-battery 1 further includes a wireless charging module 11, a thin-film battery module 12 and an antenna 13 which are printed on the first surface 101 of the flexible printed circuit board 10. The wireless charging module 11, the thin-film battery module 12 and the antenna 13 are printed on the flexible printed circuit board 10 by silk screen printing, or sensitive printing, or laser carving, or etching, or machining, for example.

The wireless charging module 11 is electrically connected to the thin-film battery module 12. In detail, the wireless charging module 11 includes a charging coil 111 and a charging coupled circuit 112. The charging coil 111 is electrically connected to the charging coupled circuit 112, and the charging coupled circuit 112 is electrically connected to the film-battery module 12. The wireless charging module 11 is configured to wirelessly receive energy supplied by a wireless powered device and convert the received energy into electric energy to charge the thin-film battery module 12.

The antenna 13 is a Wireless Fidelity antenna or a Bluetooth antenna or a Near Field Communication antenna, for example. The antenna 13 includes an antenna body 131, a signal receiving point 132 and a signal ground point 133. Two terminals of the antenna body 131 are connected to the signal receiving point 132 and the signal ground point 133 respectively. In detail, the antenna body 131 is an RF antenna coil. The signal receiving point 132 is configured to electrically connect the antenna body 131 to a wireless communication module of an electronic device (not label), and the signal ground point 133 is grounded.

As the wireless charging module 11 and the antenna 13 are printed on the flexible printed circuit board 10 directly, thus there are no independent wireless charging module and antenna, saving more space for electronic elements' assignment and reducing cost.

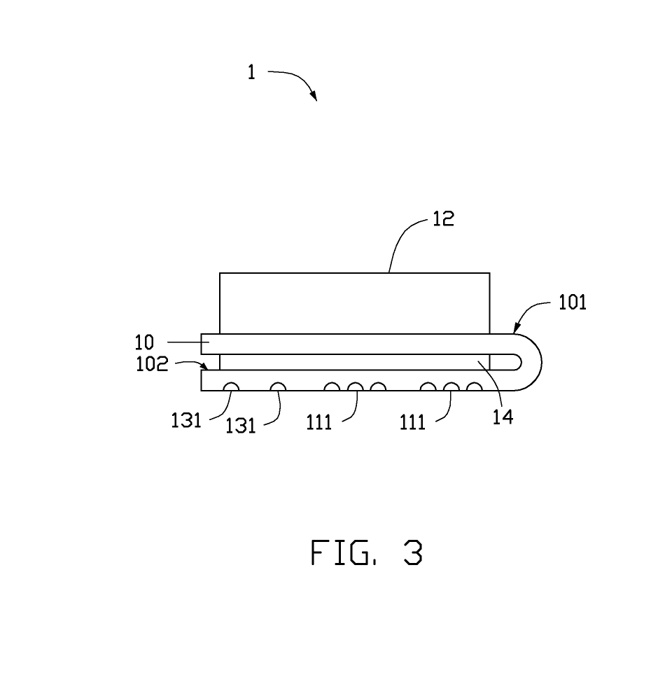

FIG. 3 shows that in another illustrated embodiment, because of the flexible printed circuit board 10 having a number of features such as high reliability, good flexibility, and light quality, the flexible printed circuit board 10 can be bent to form a U shape to further save space, with the first surface 101 being the outside surface and the second surface 102 being the interior surface of the U shape flexible printed circuit board 10.

The wireless charging film-battery 1 further includes an isolation layer 14 which is arranged between the second surface 102 of the U shape flexible printed circuit board 10 to avoid the mutual interface between the thin-film battery module 12 and the antenna 13 so as to ensure the communication quality.

It is to be understood, however, that even though numerous characteristics and advantages of the present disclosure have been set forth in the foregoing description, together with details of the structure and function of the present disclosure, the present disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. A wireless charging thin-film battery comprising
a flexible printed circuit board which comprises a first surface and a second surface opposite to the first surface,
a film-battery module which is arranged on the first surface of the flexible printed circuit board;
a wireless charging module and
an antenna, wherein both the wireless charging module and the antenna are printed on the first surface of the flexible printed circuit board and the wireless charging module is electronically connected to the thin-film battery module.

2. The wireless charging thin-film battery according to claim 1, wherein the wireless charging module comprises a charging coil and a charging coupled circuit, the charging coil is electrically connected to the charging coupled circuit, and the charging coupled circuit is electrically connected to the thin-film battery module.

3. The wireless charging thin-film battery according to claim 1, wherein the antenna comprises an antenna body, a signal receiving point and a signal grounded point, two terminals of the antenna body are connected to the signal receiving point and the signal grounded point respectively.

4. The wireless charging thin-film battery according to claim 3, wherein the antenna body is an antenna coil.

5. The wireless charging thin-film batter according to claim 4, wherein the antenna is a Wireless Fidelity antenna or a Bluetooth antenna or a Near Field Communication antenna.
